(19) United States
(12) Patent Application Publication
(10) Pub. No.: US 2003/0197738 A1
(43) Pub. Date: Oct. 23, 2003

(54) Navigational, scalable, scrolling ribbon

(76) Inventors: Eli Beit-Zuri, San Francisco, CA (US); James Berney, San Francisco, CA (US); Martine Freiberger, Redwood City, CA (US); Pamela Thompson, San Francisco, CA (US); Michal Anne Quakenbush, San Anselmo, CA (US)

Correspondence Address: WAGNER, MURABITO & HAO LLP, Third Floor, Two North Market Street, San Jose, CA, 95113, US

(21) Appl. No.: 10/127,152

(22) Filed: Apr. 18, 2002

(51) Int. Cl. G09G 5/00

(52) U.S. Cl. 345/786

(57) ABSTRACT

A method for navigating within a software application of an electronic device, such as a computer, personal digital assistant or global positioning system, using a scrolling navigational ribbon. In one embodiment, information is obtained by scrolling the ribbon to the left or right by clicking on left or right arrows until the user-selectable descriptive title of the required information appears. In another embodiment, the ribbon is scrolled by clicking on a grab bar beneath the ribbon and moving it to the right or left. The user then clicks on the required title, and the information appears on the screen. The descriptive title is placed in a field above the ribbon, known as the breadcrumb field. When the required information is more than one layer down in the hierarchy of the information database, descriptive titles on the scrolling ribbon change with each selection to reflect the next layer of information.

### FIELD OF THE INVENTION

The present invention relates to the field of graphical user interfaces (GUIs). Specifically, embodiments relate to a graphical user interface that may be used in one implementation to facilitate the selection of available software application options from a display screen of an electronic device.

### BACKGROUND OF THE INVENTION

There exist today many software applications operating on electronic devices with display screens that allow users to interface with the software by means of graphical user interfaces (GUIs). One tool that exists for aiding a user of graphical user interfaces is a list of descriptive titles of information or options from which to select the information the user requires. In the case of software applications with numerous options, this list is often quite extensive.

One example of a graphical user interface with selectable options is illustrated in FIG. 1. GUI 100 is shown in which tabs 110 may contain the names or descriptive titles of available options. The width of the tabs and, therefore, the number of tabs that may be displayed on a single line is variable, based on the length of the descriptive title that they contain. Some languages typically use longer words (e.g., German) than others, so the width of the tab may also be dependent upon the language of the GUI.

FIG. 1 illustrates a GUI for an application having more than 18 options available. In this illustration, tabs for nine (9) options fit across the screen. A second row of tabs is displayed so that 18 options can be viewed at once. The number of tabs fitting across the screen is necessarily dependent upon the length of the descriptive titles they contain. As rows of tabs are added, the vertical space on the screen, which is a prize commodity, is usurped. As the display becomes visually more “busy,” it becomes increasingly difficult to view the displayed available options.

One approach that has been used, in an effort to simplify the GUI display, is illustrated by the “more” button 120 shown in GUI 100 of FIG. 1. In this approach, the number of tabs which is displayed at one time is limited to two (2) rows and, by selecting “more” button 120, descriptive titles of another set of options may be displayed on the rows of tabs.

Options may be selected by placing the cursor at the tab having the descriptive title of the desired option and either clicking a cursor control device (e.g., mouse) or pressing enter on a keyboard. The desired information may then be displayed on the screen or, in some instances, a second (or third, etc.) level of options may appear. In the instances where additional levels of options exist, e.g., in web applications which have multiple categories, tasks or views, they may be taking up additional vertical screen space and, in doing so, creating a display that is increasingly harder and harder to read.

A need exists, therefore, for a user-friendly method or mechanism for navigating within certain software applications via a graphical user interface. Furthermore, such a method or mechanism should be much more user-friendly than currently available, enabling a user to easily locate and select from multiple options leading to obtaining desired information.

### SUMMARY OF THE INVENTION

A software application navigation tool, called a scrolling navigational ribbon, is disclosed. This scrolling navigational ribbon provides a user-friendly method and mechanism for navigating within software applications via a graphical user interface.

A method for navigating within a browser of an electronic device, such as a computer, a personal digital assistant or a global positioning system, using a scrolling navigational ribbon is described. In one embodiment, information is obtained by scrolling the ribbon to the left or right by clicking on left or right arrows until the user-selectable descriptive title of the required information appears. In another embodiment, the ribbon is scrolled by clicking on a grab bar beneath the ribbon and dragging it to the right or left. The user then clicks on the required title, the selection is highlighted and the information appears on the screen. The descriptive title is placed in a field above the ribbon, known as the breadcrumb field. When the required information is more than one layer down in the information hierarchy, a unique scrolling navigational ribbon will be displayed for each layer of the hierarchy. The descriptive titles on the scrolling ribbon change with each selection to reflect the next layer of descriptive titles in the hierarchy. Hierarchical descriptions of upper levels are displayed in the breadcrumb area, thus preserving the context of the user's salection path.

For example, a user interface comprising a scrolling navigational ribbon is described. The scrolling navigational ribbon comprises a first plurality of descriptive titles of a first set of user-selectable information, displayed on a display screen of an electronic device. The user interface further comprises a left arrow and a right arrow, displayed adjacent to the scrolling navigational ribbon, for horizontally scrolling the navigational ribbon. A grab bar is displayed below the scrolling navigational ribbon for scrolling the navigational ribbon.

According to one embodiment, a user interface is described that resides on an electronic device e.g., a computer. According to another embodiment, the electronic device is a personal digital assistant. In one embodiment, the electronic device is a portable electronic device.

In one embodiment, a user interface is described wherein the user scrolls the scrolling navigational ribbon by placing a cursor over the left or right arrow and clicking a cursor control device. In another embodiment, the user scrolls the scrolling navigational ribbon by placing a cursor over the grab bar, holding down a cursor control device and moving the grab bar to the right or the left.

A user interface is described wherein, upon the user selecting a first descriptive title from the scrolling navigational ribbon, according to one embodiment, the information described by the first descriptive title is displayed on the display screen and the first descriptive title is displayed in a field above the scrolling navigational ribbon as a hierarchical breadcrumb field.

In one embodiment, a user interface is described wherein, upon the user selecting the first descriptive title, the scrolling navigational ribbon comprises a second plurality of descriptive titles, the second plurality of descriptive titles describing a second set of user-selectable information related to the first descriptive title. In one embodiment, a user interface is described wherein the field above the scrolling navigational ribbon is a breadcrumb field.

According to one embodiment of the present invention, a user interface is described wherein, upon the user selecting a second descriptive title from the second plurality of descriptive titles, the first descriptive title and the second descriptive title are displayed in the breadcrumb field and corresponding information from the second set of information is displayed on the display screen. In one embodiment, navigation is reversed by the user selecting the descriptive title of required information within the breadcrumb field and clicking the cursor control device.

These and other advantages of the present invention will become obvious to those of ordinary skill in the art after having read the following detailed description of the preferred embodiments which are illustrated in accompanying drawings, illustrating by way of example the principles of the invention.

### BRIEF DESCRIPTION OF THE DRAWINGS

FIG. 1 illustrates a display screen showing a graphical user interface for navigating within a software application according to the prior art.

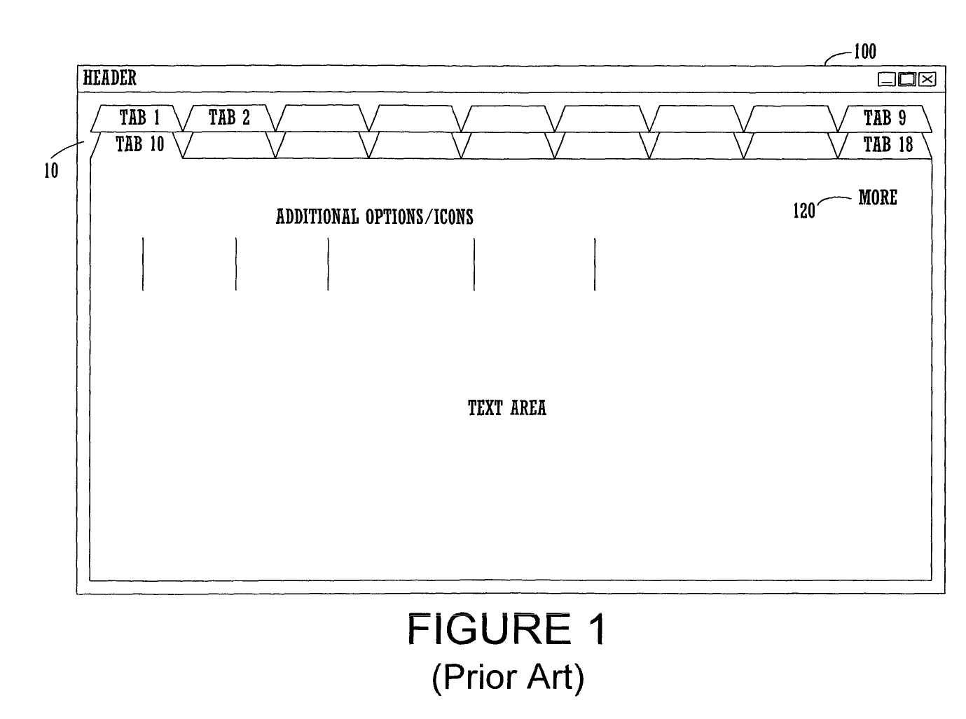

FIG. 2 is a block diagram of an exemplary computer system upon which an embodiment of the present invention may be practiced.

FIG. 3 is an exemplary screen shot illustrating a display window of a user interface with a scrolling navigational ribbon according to an embodiment of the present invention.

FIG. 4 is an exemplary screen shot illustrating a display window of a user interface positioned for scrolling to the right according to an embodiment of the present invention.

FIG. 5 is an exemplary screen shot illustrating a display window of a user interface positioned for scrolling left according to an embodiment of the present invention.

FIG. 5A illustrates a navigational ribbon used for scrolling right according to one embodiment of the present invention.

FIG. 5B illustrates a navigational ribbon used for scrolling left according to one embodiment of the present invention

FIG. 6 is an exemplary screen shot illustrating a display window of a user interface positioned for scrolling with a grab bar according to an embodiment of the present invention.

FIG. 7 is a flow diagram of a computer implemented process for navigating within a software application in accordance with an embodiment of the present invention.

FIG. 7A illustrates a navigational ribbon populated by a first set of descriptive titles, according to one embodiment.

FIG. 7B illustrates a navigational ribbon populated by a second set of descriptive titles, according to one embodiment.

FIG. 7C illustrates a navigational ribbon populated by a third set of descriptive titles according to one embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Notation and Nomenclature

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic information capable of being stored, transferred, combined, compared, and otherwise manipulated in a computer system. It has proven convenient at times, principally for reasons of common usage, to refer to these information as transactions, bits, values, elements, symbols, characters, fragments, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “analyzing,” “determining,” “using,” “scrolling,” “navigating,” “displaying,” “placing” or the like, refer to actions and processes of a computer system or similar electronic computing device. The computer system or similar electronic computing device manipulates and transforms data represented as physical (electronic) quantities within the computer system memories, registers or other such information storage, transmission or display devices. The present invention is well suited to the use of other computer systems.

Exemplary Computer System

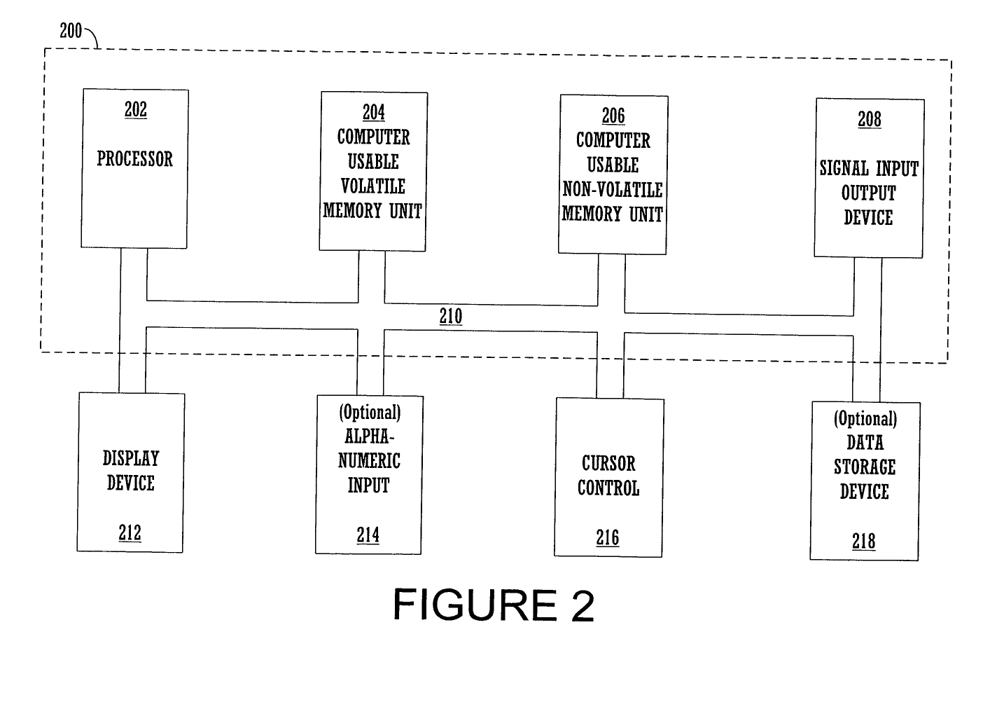

FIG. 2 is a block diagram of one embodiment of an exemplary computer system 200 used in accordance with the present invention. It should be appreciated that system 200 is not strictly limited to be a computer system. As such, system 200 of the present embodiment is well suited to be any type of computing device (e.g., server computer, portable computing device, desktop computer, personal digital assistant, embedded system, global positioning system, etc.). Within the following discussions of the present invention, certain processes and steps, e.g., process 700 are discussed that are realized, in one embodiment, as a series of instructions (e.g., software program) that reside within computer readable memory units of computer system 200 and executed by a processor(s) of system 200. When executed, the instructions cause computer 200 to perform specific actions and exhibit specific behavior that is described in detail below.

Computer system 200 of FIG. 2 comprises an address/data bus 210 for communicating information and one or more central processors 202 coupled with bus 210 for processing information and instructions. Central processor unit(s) 202 may be a microprocessor or any other type of processor. The computer 200 also includes data storage features such as a computer usable volatile memory unit 204 (e.g., random access memory, static RAM, dynamic RAM, etc.) coupled with bus 210 for storing information and instructions for central processor(s) 202, a computer usable non-volatile memory unit 206 (e.g., read only memory, programmable ROM, flash memory, EPROM, EEPROM, etc.) coupled with bus 210 for storing static information and instructions for processor(s) 202. System 200 also includes one or more signal generating and receiving devices 208 coupled with bus 210 for enabling system 100 to interface with other electronic devices and computer systems. The signal generating and receiving device(s) 208 of the present embodiment may include wired and/or wireless communication technology. For example, within the present embodiment, the communication interface 208 is a serial communication port, but could also alternatively be any of a number of well known communication standards and protocols, e.g., Universal Serial Bus (USB), Ethernet, FireWire (IEEE 1394), parallel, small computer system interface (SCSI), infrared (IR) communication, Bluetooth wireless communication, broadband, and the like.

Optionally, computer system 200 may include an alphanumeric input device 214 including alphanumeric and function keys coupled to the bus 210 for communicating information and command selections to the central processor(s) 202. The computer 200 includes a cursor control or cursor directing device 216 coupled to the bus 210 for communicating user input information and command selections to the central processor(s) 202. The cursor directing device 216 can be implemented using a number of well known devices such as a mouse, a track-ball, a track-pad, an optical tracking device, a touch screen, etc. Alternatively, it is appreciated that a cursor can be directed and/or activated via input from the alphanumeric input device 214 using special keys and key sequence commands. The present embodiment is also well suited to directing a cursor by other means such as, for example, voice commands. The system 200 can also include a computer usable mass data storage device 218 such as a magnetic or optical disk and disk drive (e.g., hard drive or floppy diskette) coupled with bus 210 for storing information and instructions. An display device 212 is coupled to bus 210 of system 200 for displaying video and/or graphics. It should be appreciated that display device 212 may be a cathode ray tube (CRT), flat panel liquid crystal display (LCD), field emission display (FED), plasma display or any other display device suitable for displaying video and/or graphic images and alphanumeric characters recognizable to a user.

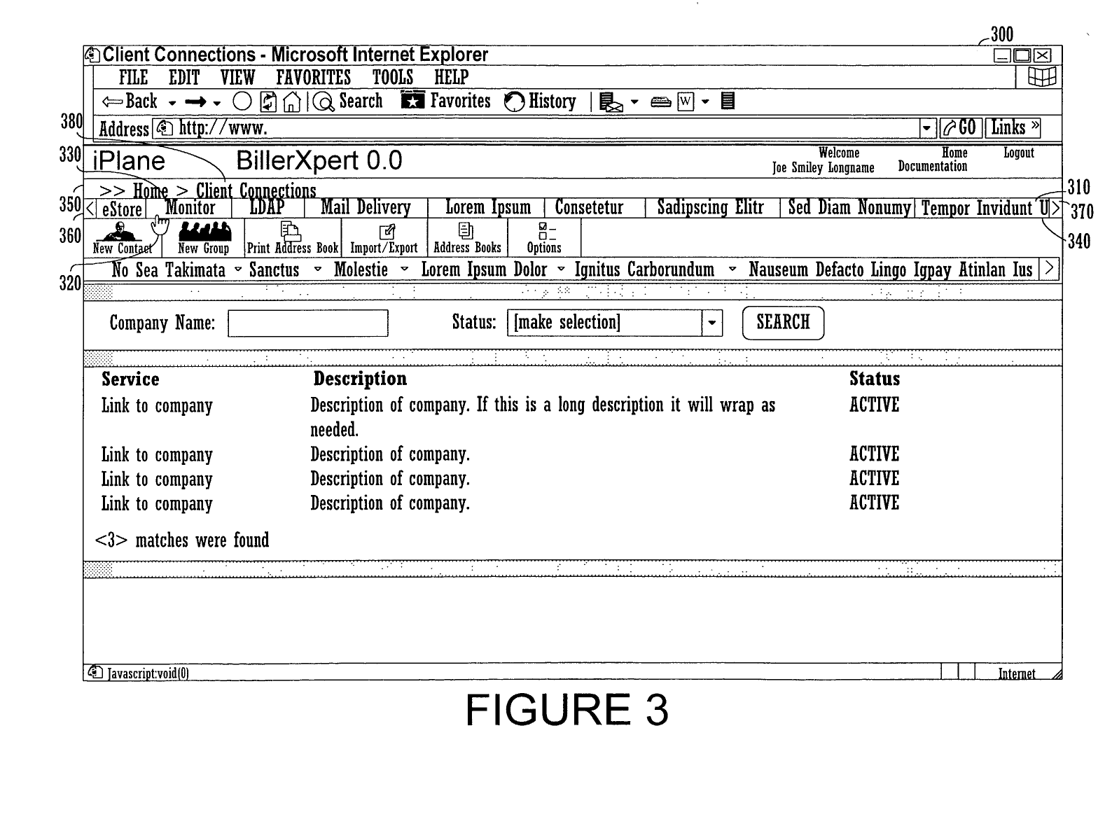

FIG. 3 is an exemplary computer screen shot illustrating a display window 300 of a user interface with a scrolling navigational ribbon 310 according to an embodiment of the present invention. Scrolling navigational ribbon 310 contains a list of multiple descriptive titles 330 of information that may be selected by a user. The descriptive titles 330 are arranged horizontally across the ribbon 310, separated by spaces. A large number of descriptive titles 330 may be available on the ribbon, and, although all may not be viewable at one time, ribbon 310 may be scrolled to the right or left for purposes of viewing additional descriptive titles 330.

In one embodiment, the scrolling navigational ribbon 310 of FIG. 3 may be scrolled to the left using left button 360. In one embodiment, the ribbon 310 may be scrolled to the right using right button 370. In another embodiment, the ribbon may be scrolled to the left and to the right using grab bar 340, e.g., clicking on the bar and moving the cursor directly to the left or right. In one embodiment, the computer screen may be of sufficient size to accommodate all descriptive titles across the screen when the window is stretched to fit the screen, In this instance, the scrolling buttons and grab bar will cease to be displayed. The keyboard actions of this invention are designed to be compliant with Section 508 of the Federal IT Accessability Initiative in that they allow people with disabilities to have access to the graphical user interface.

The arrangement of the descriptive titles 330 on scrolling navigational ribbon 310, according to the present embodiment, does not restrict the length of titles that can be displayed. Thus the ribbon allows for scalable fields. To obtain required information, a user places a cursor over the associated descriptive title 330 until the cursor changes display attributes, e.g., changes to a pointing hand 320. The user then clicks the cursor control device (e.g., cursor control 216 of FIG. 2). The descriptive title that is selected may also change display attributes, e.g. becomes highlighted as shown.

Still referring to FIG. 3, once selected, the required information is displayed in display screen 300. The selected title may be represented by another list of titles, displayed in the ribbon 310, or, the selected title may invoke a new display on the display screen, e.g., a new web page. According to one embodiment, the descriptive title 330 of the displayed information is then placed in breadcrumb field 350. Breadcrumb field 350 keeps a hierarchical list of selected descriptive titles 330 and subtitles. According to one embodiment, to obtain required information a user may need to make a series of selections of descriptive titles 330, each subordinate to the previous one and in a hierarchical tree organization. In this embodiment, once a first descriptive title 330 is selected, it is placed in the breadcrumb field 350 and a new set of descriptive titles, referred to herein as the second level titles, is displayed in scrolling navigational ribbon 310.

In accordance with one embodiment of the present invention, upon user selection of a second level title, that title is also written to the breadcrumb field 350, separated from the first title by appropriate spacing or punctuation, e.g., “>”. There is no limit to the number of levels of information that may be traversed to obtain the required information. Therefore, breadcrumb field 350 allows the user to view the path followed to reach the information displayed.

The breadcrumb field 350 is also, in accordance with one embodiment, a reverse navigational tool. A user may select a descriptive title 380 from breadcrumb field 350 to cause the scrolling navigational ribbon 310 to display the descriptive titles 330 corresponding to descriptive title 380, thus allowing a user to back up to a higher level of information.

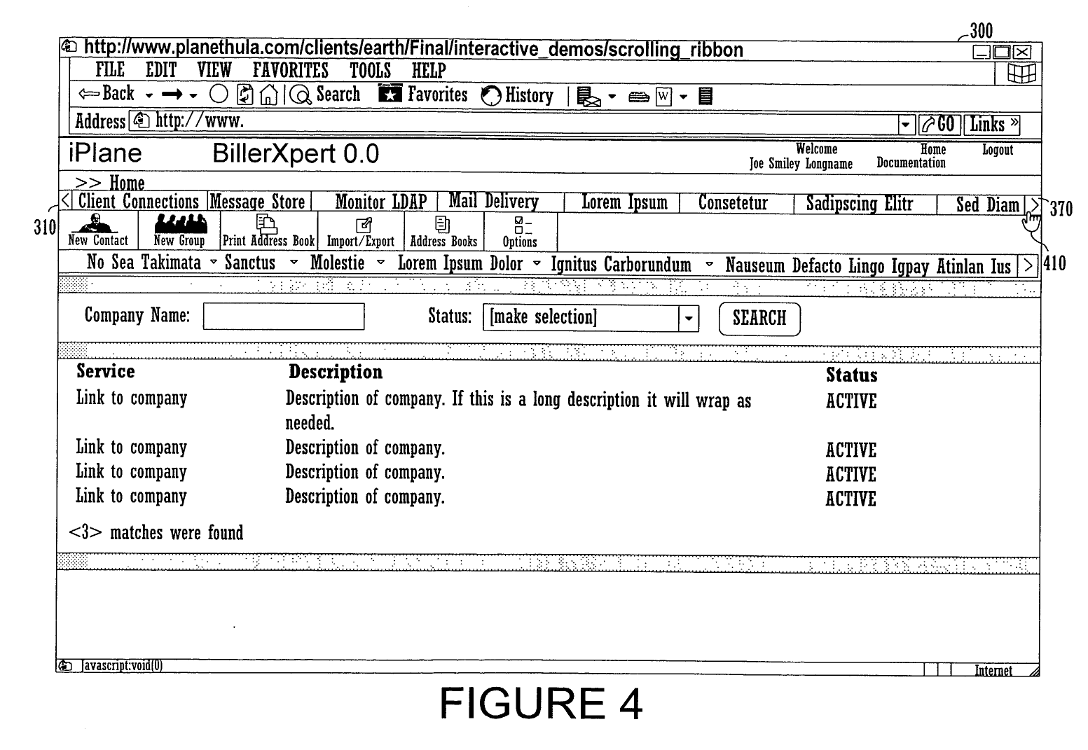

FIGS. 4, 5 and 6 are exemplary screen shots illustrating display window 300 of a user interface, showing positions for scrolling with right button 370, scrolling with left arrow 360 and scrolling with grab bar 340, in accordance with embodiments of the present invention.

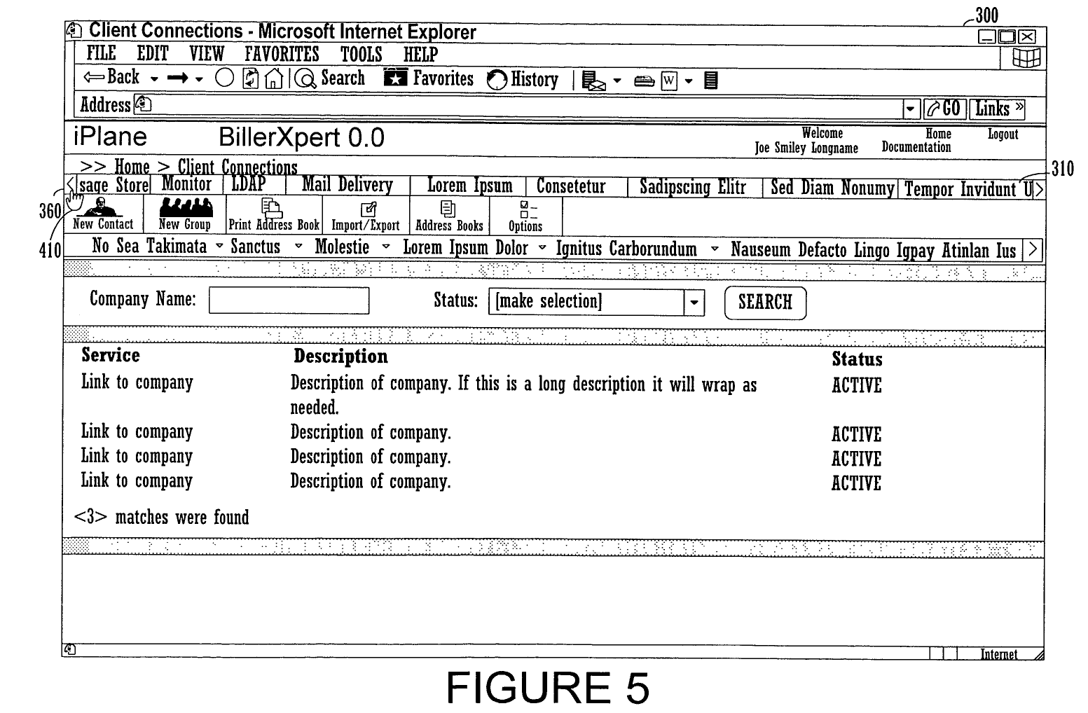

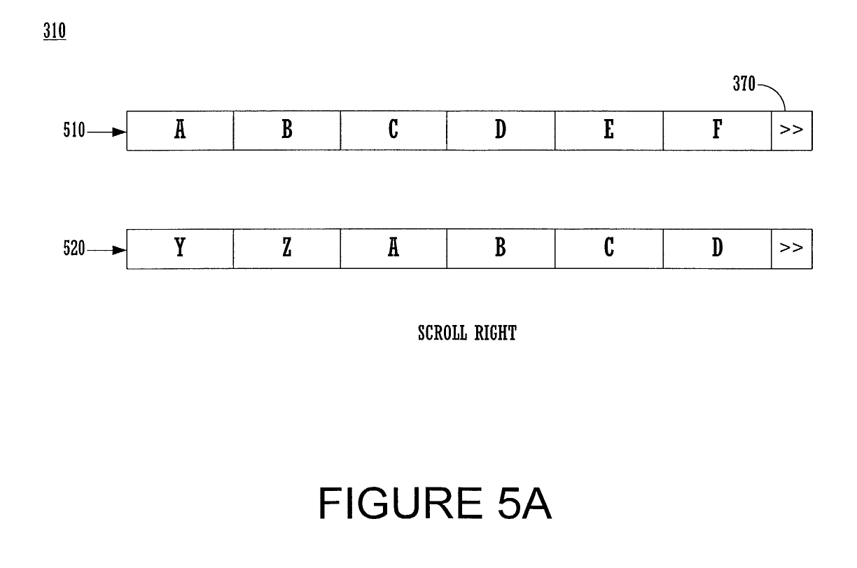

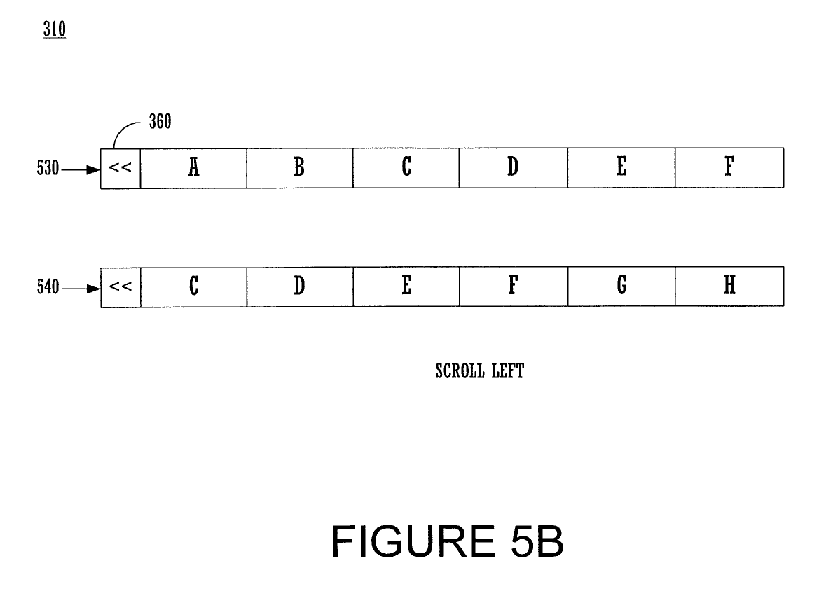

FIGS. 5A and 5B illustrate the navigational ribbon displaying descriptive title positions before and after scrolling, according to one embodiment of the present invention.

FIG. 4 illustrates a user interface with the cursor 410 positioned for scrolling to the right according to an embodiment of the present invention. Once cursor 410 is positioned above right button 370, cursor 410 becomes a pointing hand. The user may activate, through selection, the cursor control (e.g., cursor control 216 of FIG. 2) to cause scrolling navigational ribbon 310 to scroll to the right so that additional descriptive titles 330 that may be hidden from view to the left of display window 300 may be viewed. Refer to FIG. 5A for an illustration of navigational ribbon 310 in a before-scrolling position 510 and in an after-scrolling-right position 520.

FIG. 5 illustrates a user interface with cursor 410 positioned for scrolling to the left, according to another embodiment of the present invention. Scrolling to the left is performed the same as scrolling to the right, except that the left button 360 is selected and descriptive titles 330 that may be hidden from view on scrolling navigational ribbon 310 to the right of display window 300 may be viewed. FIG. 5B illustrates navigational ribbon 310 in a before-scrolling position 530 and an after-scrolling-left position 540.

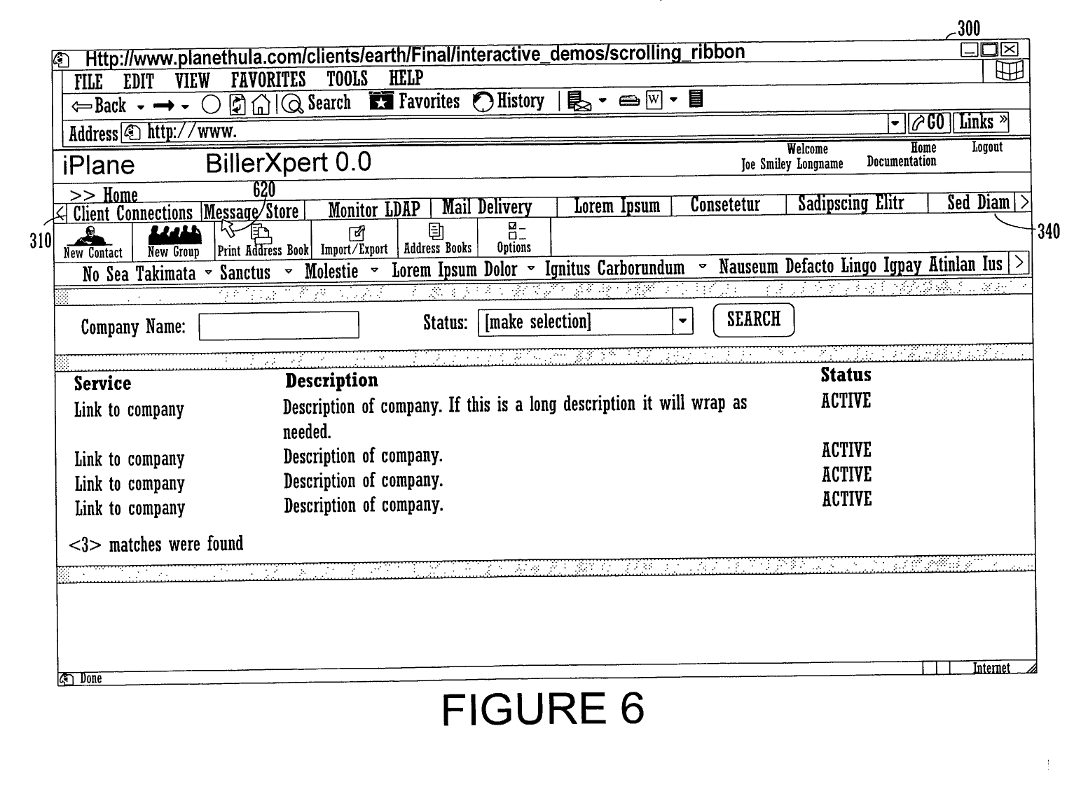

FIG. 6 is an exemplary screen shot illustrating a display window of a user interface positioned for scrolling with grab bar 340, in accordance with one embodiment of the present invention. To scroll navigational ribbon 310 to the left or right, a user positions the cursor near grab bar 340. By holding down cursor control 216 and moving the cursor to the left or right, scrolling navigational ribbon 310 will scroll to the left or right, respectively.

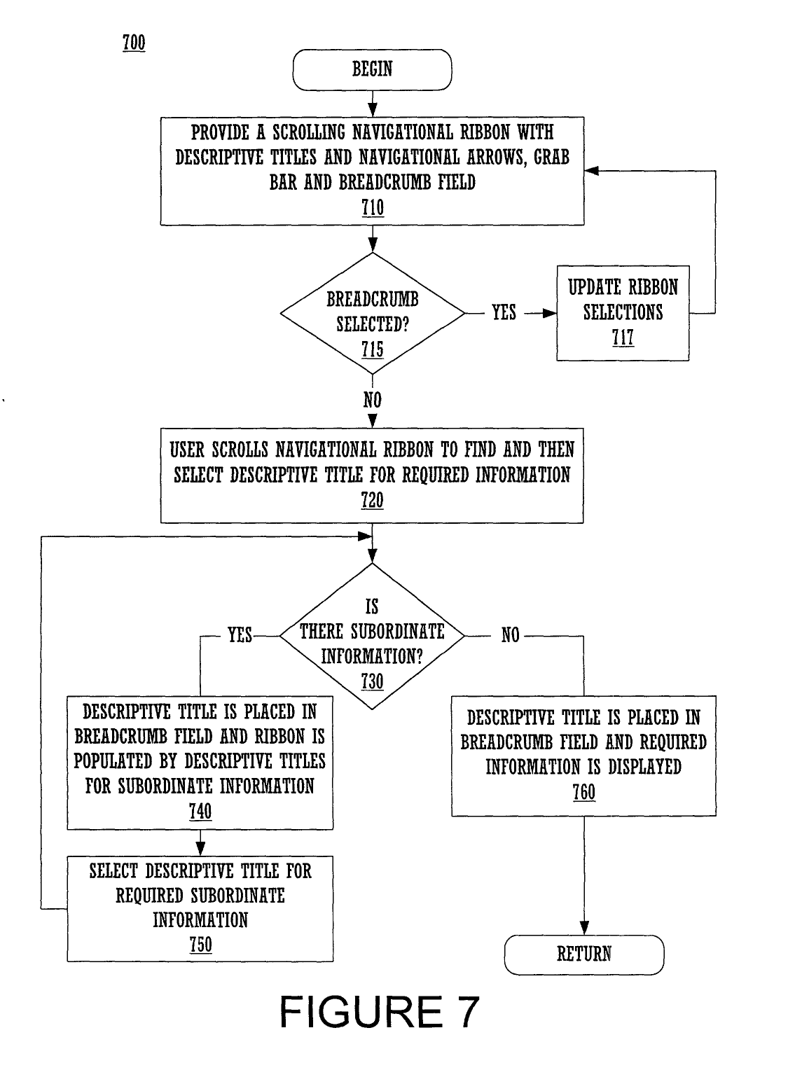

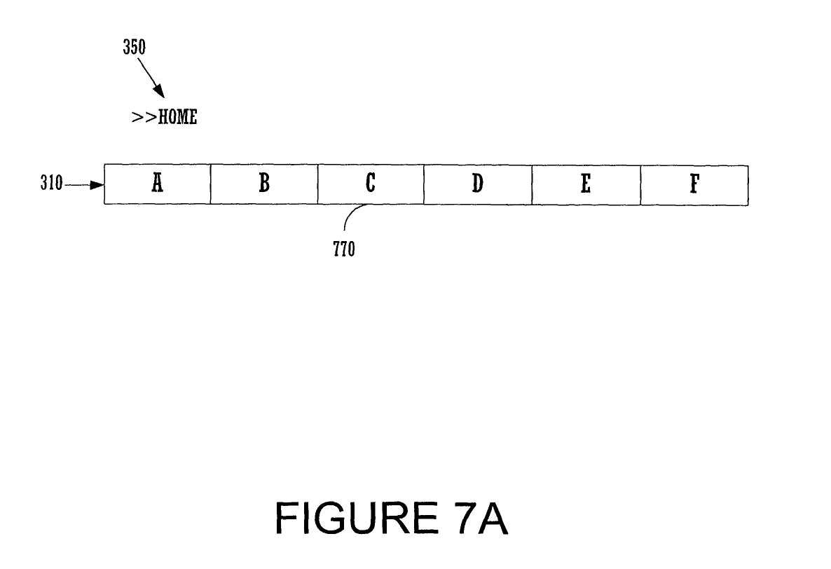

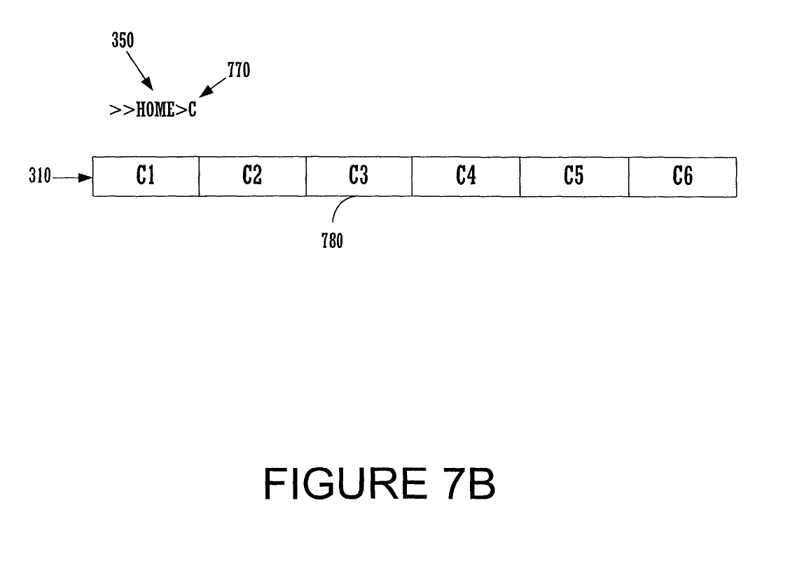

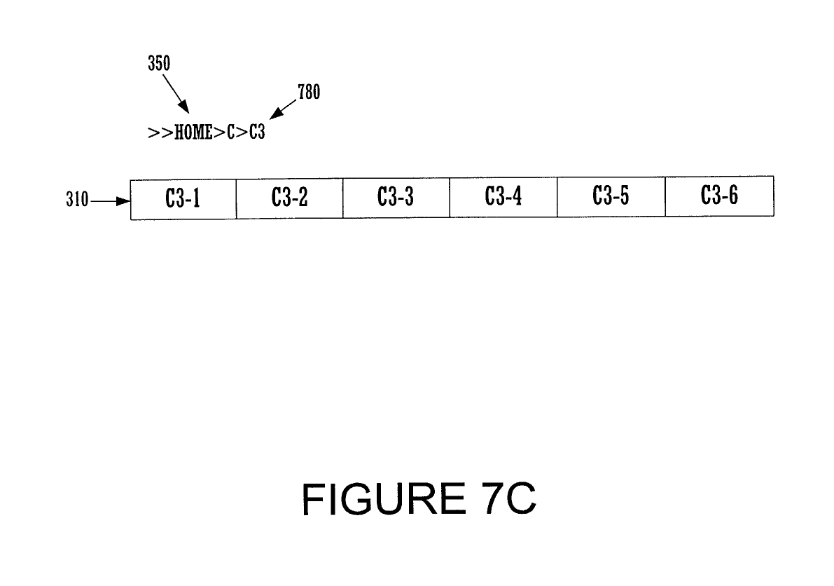

FIG. 7 is a computer implemented flow diagram of process 700 for navigating within a software application in accordance with an embodiment of the present invention. At step 710, a display window of an electronic device (e.g., device 200 of FIG. 2) is provided, in one embodiment, with a scrolling navigational ribbon (e.g., navigational ribbon 310 of FIG. 3) having descriptive titles (e.g., titles 330 of FIG. 3). Also provided at step 710 are navigational left and right arrows (e.g., arrows 360 and 370 of FIG. 3), a grab bar (e.g., grab bar 340 of FIG. 3) and a breadcrumb field (e.g., breadcrumb field 350 of FIG. 3).

According to one embodiment of the present invention, to return to any level of information within the hierarchy, referred to herein as reverse navigation, the user needs only to select the desired descriptive title 330 within the breadcrumb field 350 shown in step 715 of FIG. 7. If the breadcrumb field is selected, the process returns to the level of the selected title 330, placing the descriptive titles associated with that level into the scrolling navigational ribbon 310, as shown in step 717. The process then returns to step 710. If a breadcrumb field is not selected, process 700 proceeds to step 720.

At step 720, according to one embodiment, a user scrolls navigational ribbon 310 to the left or right, using either left arrow 360 or right arrow 370 or grab bar 340 or the tab key on the keyboard until the descriptive title 330 of required information is located. According to one embodiment, once the title 330 of required information is located, the user may select the required information by positioning a cursor at the location of the descriptive title 330 and activating the cursor control (e.g., cursor control 216 of FIG. 2) or the enter key on the keyboard.

At step 730, according to one embodiment, if there is no subordinate information to the selected descriptive title 330, process 700 proceeds to step 760. If there is subordinate information to descriptive title 330, process 700 proceeds to step 740. FIGS. 7A, 7B and 7C illustrate scrolling navigational ribbon 310 and breadcrumb field 350 according to embodiments of the present invention. FIG. 7A illustrates navigational ribbon 310 populated by a first set of descriptive titles, and breadcrumb field displaying “Home”, corresponding to the first level of titles according to one embodiment. In FIG. 7A, descriptive title “C” 770 illustrates the descriptive title being selected.

At step 740, in accordance with one embodiment of the present invention, selected descriptive title (e.g., descriptive title 770 of FIG. 7B) is placed in breadcrumb field 350. Scrolling navigational ribbon 310 is then populated by a second set of descriptive titles describing the subordinate information as shown in FIG. 7B. The user may then, according to one embodiment, as shown in step 750, select a descriptive title (e.g., descriptive title 780 of FIG. 7B) from the scrolling navigational ribbon according to the procedure in step 720 above. The process then returns to step 730 where, if there is additional subordinate information, steps 740 and 750 are once again repeated. According to one embodiment, the descriptive titles 330 of information selected at each entry to step 740 are placed sequentially in the breadcrumb field, as illustrated in FIG. 7C, thus marking the hierarchy of the navigational process.

When there is no additional subordinate information, according to one embodiment, process 700 proceeds to step 760 and displays the required information. Upon completion of step 760, the present embodiment exits flowchart 700.

Although specific steps are disclosed in flowchart 700, such steps are exemplary. That is, the present invention is well suited to performing various other steps or variations of the steps recited in FIG. 7.

In summary, embodiments of the present invention provide A method for navigating within a software application of an electronic device, such as a computer, personal digital assistant or global positioning system, using a scrolling navigational ribbon.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A computer implemented user interface comprising:
a scrolling navigational ribbon comprising a first plurality of descriptive titles of a first set of user-selectable information, displayed on a display screen of an electronic device;
a left button and a right button displayed adjacent to said scrolling navigational ribbon and for horizontally scrolling said navigational ribbon to the left and to the right, respectively for the display of additional descriptive titles within said navigational ribbon; and
a grab bar displayed below said scrolling navigational ribbon and for also scrolling said navigational ribbon.

2. A user interface as described in claim 1 integrated within a web application.

3. A user interface as described in claim 1 wherein said electronic device is a personal digital assistant.

4. A user interface as described in claim 1 wherein said electronic device is a portable electronic device.

5. A user interface as described in claim 1 wherein said user scrolls said scrolling navigational ribbon by placing a cursor over said left or right button and activating a cursor control device.

6. A user interface as described in claim 1 wherein said user scrolls said scrolling navigational ribbon by placing a cursor over said grab bar, activating a cursor control device and moving said grab bar to the right or the left.

7. A user interface as described in claim 1 wherein, upon said user selecting a first descriptive title from said scrolling navigational ribbon, said information described by said first descriptive title is displayed on said display screen and said first descriptive title is displayed in a field adjacent to said scrolling navigational ribbon.

8. A user interface as described in claim 7 wherein, upon said user selecting said first descriptive title, said scrolling navigational ribbon displays a second plurality of descriptive titles, said second plurality of descriptive titles describing a second set of user-selectable information hierarchically related to said first descriptive title.

9. A user interface as described in claim 7 wherein said field adjacent to said scrolling navigational ribbon comprises a hierarchical listing of all selected descriptive titles from said navigational ribbon.

10. A user interface as described in claim 8 wherein, upon said user selecting a second descriptive title from said second plurality of descriptive titles, said first descriptive title and said second descriptive title are displayed in said field and corresponding information related to said second descriptive title is displayed on said display screen in response.

11. A user interface as described in claim 10 wherein navigation is reversed by said user selecting any descriptive title within said field and activating said cursor control device.

12. A method for navigating within a software application comprising:
a) displaying a navigational ribbon display of a portion of a first plurality of descriptive titles of a first set of user-selectable information on a display screen of an electronic device;
b) displaying a first scroll button and a second scroll button displayed adjacent to said navigational ribbon;
c) displaying a grab bar adjacent to said navigational ribbon;
d) scrolling said navigational ribbon in a first direction by activating said first scroll button;
e) scrolling said navigational ribbon in a second direction by activating said second scroll button;
f) scrolling said navigational ribbon by interfacing with said grab bar; and
g) selecting a first descriptive title from said navigational ribbon.

13. A method as described in claim 12 wherein said software application is integrated within a web application.

14. A method as described in claim 12 wherein said electronic device is a personal digital assistant.

15. A method as described in claim 12 wherein said electronic device is a portable electronic device.

16. A method as described in claim 12 wherein said d) and e) are performed by placing a cursor over said first or second scroll button and activating a cursor control device.

17. A method as described in claim 12 wherein said f) is performed by placing a cursor over said grab bar, activating a cursor control device and moving said grab bar to the right or the left.

18. A method as described in claim 12 wherein, upon said g), said information described by said first descriptive title is displayed on said display screen and said first descriptive title is displayed in a field adjacent to said navigational ribbon.

19. A method as described in claim 18 wherein, upon said selecting said first descriptive title, said navigational ribbon displays a second plurality of descriptive titles, said second plurality of descriptive titles describing a second set of user-selectable information hierarchically related to said first descriptive title.

20. A method as described in claim 18 wherein said field adjacent to said navigational ribbon comprises a hierarchical listing of all selected descriptive titles from said navigational ribbon.

21. A method as described in claim 19 wherein, upon selecting a second descriptive title from said second plurality of descriptive titles, said first descriptive title and said second descriptive title are displayed in said field and corresponding information related to said second descriptive title is displayed on said display screen in response.

22. A method as described in claim 21 wherein navigation is reversed by selecting any descriptive title within said field and activating said cursor control device.

23. A user interface comprising:
a scrolling navigational ribbon displaying a first portion of a first plurality of descriptive titles providing a means for accessing a first set of user-selectable information, said scrolling navigational ribbon displayed on a display screen of an electronic device;
a left button and a right button displayed adjacent to said scrolling navigational ribbon providing a means for horizontally scrolling said navigational ribbon to the left and to the right, respectively; and
a grab bar displayed below said scrolling navigational ribbon providing a means for also scrolling said navigational ribbon.

24. A user interface as described in claim 23 integrated within a web application.

25. A user interface as described in claim 23 wherein said electronic device is a personal digital assistant.

26. A user interface as described in claim 23 wherein said electronic device is a portable electronic device.

27. A user interface as described in claim 23 wherein said user scrolls said scrolling navigational ribbon by placing a cursor over said left or right button and activating a cursor control device.

28. A user interface as described in claim 23 wherein said user scrolls said scrolling navigational ribbon by placing a cursor over said grab bar, activating a cursor control device and moving said grab bar to the right or the left.

29. A user interface as described in claim 23 wherein, upon said user selecting a first descriptive title from said scrolling navigational ribbon, said information described by said first descriptive title is displayed on said display screen and said first descriptive title is displayed in a field adjacent to said scrolling navigational ribbon.

30. A user interface as described in claim 29 wherein, upon said user selecting said first descriptive title, said scrolling navigational ribbon displays a second plurality of descriptive titles, said second plurality of descriptive titles describing a second set of user-selectable information hierarchically related to said first descriptive title.

31. A user interface as described in claim 29 wherein said field adjacent to said scrolling navigational ribbon comprises a hierarchical listing of all selected descriptive titles from said navigational ribbon.

32. A user interface as described in claim 30 wherein, upon said user selecting a second descriptive title from said second plurality of descriptive titles, said first descriptive title and said second descriptive title are displayed in said field and corresponding information related to said second descriptive title is displayed on said display screen in response.

33. A user interface as described in claim 32 wherein navigation is reversed by said user selecting any descriptive title within said field and activating said cursor control device.
